(19) United States
(12) Patent Application Publication
(10) Pub. No.: US 2008/0315063 A1
(43) Pub. Date: Dec. 25, 2008

(54) Keyhole mounting system

(75) Inventor: James M. Gallien, Hidden Hills, CA (US)

Correspondence Address: STETINA BRUNDA GARRED & BRUCKER, 75 ENTERPRISE, SUITE 250, ALISO VIEJO, CA, 92656, US

(73) Assignee: Hangman Products, Inc.

(21) Appl. No.: 11/821,766

(22) Filed: Jun. 25, 2007

(51) Int. Cl. F16M 13/02

(52) U.S. Cl. 248/544

(57) ABSTRACT

There is provided a wall mounting kit including a pair of fasteners that are cooperatively engageable with a wall. The wall mounting kit further includes a wall fixture having a reference edge and a contact surface. The contact surface is adjacent to the wall when the wall fixture is secured thereto. A pair of keyhole openings is disposed within the contact surface. The spatial separation the keyhole openings and the reference edge defines a first distance. Each keyhole opening includes an aperture portion. The spatial separation between the centers of the keyhole aperture portions defines a second distance. The keyhole openings are operative to receive a respective one of the pair of fasteners such that the wall fixture is secured to the wall. The wall mounting kit additionally includes a template having a marking guide operative to illustrate the second distance.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND

The present invention relates generally to wall mounted decorations and/or fixtures. In particular, the present invention relates to a system and method for securing a support frame or similar support structure to a wall.

Walls are commonly decorated with wall decorations. Examples of such decorations may include paintings, pictures, mirrors, shelves, frames, etc. Typically, a wall decoration is secured to a wall by hanging the wall decoration on a nail, which has been inserted into the wall. The decoration may itself be supported by the nail, or it may include a wire or bracket which hangs on the nail.

Many wall decorations include a keyhole for mounting the decoration to the wall. A keyhole is a cutout built into the wall decoration and typically includes a slot which communicates with an adjacent hole. The hole opening is generally larger than the diameter of the nail head, while the slot opening is typically smaller than the diameter of the nail head. As such, the nail head may be placed within the hole, and then confined within the slot after being advanced from the hole into the slot. When the nail head is positioned within the slot, the wall decoration is effectively secured to the wall.

Although a keyhole mounting system is operative to secure a wall decoration to a wall, the process of mounting a wall decoration employing a keyhole mounting system can oftentimes be tedious and difficult. The first step usually involves finding a location on the wall where the wall decoration is to be hung. It may be desirable to center the wall decoration on the wall and also ensure the wall decoration is level with a horizontal plane. As such, a number of measurements may be made to find a level and central location. The user then marks the wall to indicate where fasteners, such as screws or nails should be inserted such that the wall decoration will be supported by the fasteners in the level and central position. A mark is commonly made on the wall with pen, pencil, or chalk. It is critical that the fasteners are correctly spaced. If the spacing between the fasteners is slightly incorrect, the fasteners may not fit into the narrow slot of the keyhole opening. If the fastener spacing is incorrect, the user may be forced to remove the fasteners from the wall, and repeat the process until they are correctly spaced. This process may be repeated multiple times before the fasteners are correctly spaced. Consequently, throughout this process, numerous holes and markings are created on the wall.

Therefore, there is a need in the art for an improved method and system of hanging wall mounted decorations/fixtures on a wall.

### BRIEF SUMMARY

According to an aspect of the present invention there is provided a wall mounting kit. The wall mounting kit includes a pair of fasteners. Each fastener is capable of being cooperatively engaged to a wall. The wall mounting kit further includes a wall fixture. The wall fixture includes a reference edge and a contact surface. The contact surface is adjacent to the wall when the wall fixture is secured thereto. The wall fixture also includes a pair of keyhole openings disposed within the contact surface. The spatial separation between the keyhole openings and the reference edge defines a first distance. Each keyhole opening includes an aperture portion. The spatial separation between the centers of the keyhole aperture portions defines a second distance. The keyhole openings are operative to receive a respective one of the pair of fasteners which are used to secure the wall fixture to the wall.

The wall mounting kit additionally includes a template having a marking guide. The marking guide is operative to illustrate the second distance. The template may have a height which is slightly less than the first distance.

The wall mounting kit may further include a leveling device that is operative to ensure that the wall fixture is level with a horizontal plane. In addition, the wall mounting kit fasteners may be double headed screws. The double headed screws may include high-helix angle threads to support larger weights.

The present invention also includes a methodology of securing a wall fixture to a wall. The method includes the step of holding the wall fixture adjacent to the wall in the desired location. A reference mark is drawn on the wall adjacent to the reference edge. The template includes a first edge which is placed adjacent to the reference mark. A pair of fastener marks is drawn on the wall in accordance with the marking guide. The spatial separation between the fastener marks is equal to the second distance. A pair of fasteners is inserted into the wall. Each fastener is inserted at a respective one of the pair of fastener marks. The wall fixture is secured to the wall by connecting the pair of fasteners with the wall fixtures such that a respective one of the pair of fasteners is inserted into a respective one of the keyhole openings.

It is contemplated that the present invention addresses the aforementioned deficiencies in the art. In particular the present invention allows a user to quickly and easily hang a wall fixture on a wall. As mentioned above, one of the most difficult and frustrating aspects of many prior art wall hanging systems and methods is ensuring that the fasteners are correctly spaced, such that they will connect with the wall fixture and that the wall fixture will be level. The template assists a user in this regard by instructing a user as to where to make the fastening marks. Such a system and method should simplify and alleviate the process of hanging a wall fixture.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a first step of a sequence of steps related to the use of a keyhole mounting system of the present invention, illustrating a wall fixture held by a user in a desired location adjacent to a wall, wherein a leveling device is placed on a wall fixture reference surface to ensure the wall fixture is level with a horizontal plane;

FIG. 2 is a perspective view of a second step of the sequence of steps related to the use of the keyhole mounting system, illustrating the wall fixture of FIG. 1, wherein the user is drawings a reference mark on the wall;

FIG. 3 is a perspective view of a third step of the sequence of steps related to the use of the keyhole mounting system, illustrating the user placing a template adjacent to the reference mark, wherein the user is drawing a reference mark in accordance with a template marking

FIG. 4 is a perspective view of a fourth step of the sequence of steps related to the use of the keyhole mounting system, illustrating the user drawing another fastener mark in accordance with a template marking guide;

FIG. 5 is a perspective view of a fifth step of a sequence of steps related to the use of the keyhole mounting system, illustrating the user inserting a pair of fasteners into the wall;

FIG. 6 is a is a perspective view of a sixth step in the sequence of steps related to the use of the keyhole mounting system, illustrating the wall fixture, wherein a pair of keyhole openings located within a wall fixture contact surface are cooperatively engaged to the pair of fasteners;

FIG. 7 is a perspective view of a seventh step in the sequence of steps related to the use of the keyhole mounting system, illustrating the wall fixture as secured to the wall;

FIG. 8 is a cross-sectional view taken along line 8-8 of FIG. 7;

FIG. 9 is a cross-sectional view taken along line 9-9 of FIG. 8;

FIG. 10 is a top perspective view of the double headed screw which may be used in conjunction with the keyhole mounting system of the present invention;

FIG. 11 is a front elevational view of the double headed screw of FIG. 10;

FIG. 12 is a rear elevational view of the double headed screw of FIG. 10; and

FIG. 13 is a perspective view of the wall fixture similar to FIG. 7, but further illustrating an attachment device coupled to the wall fixture and the wall.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

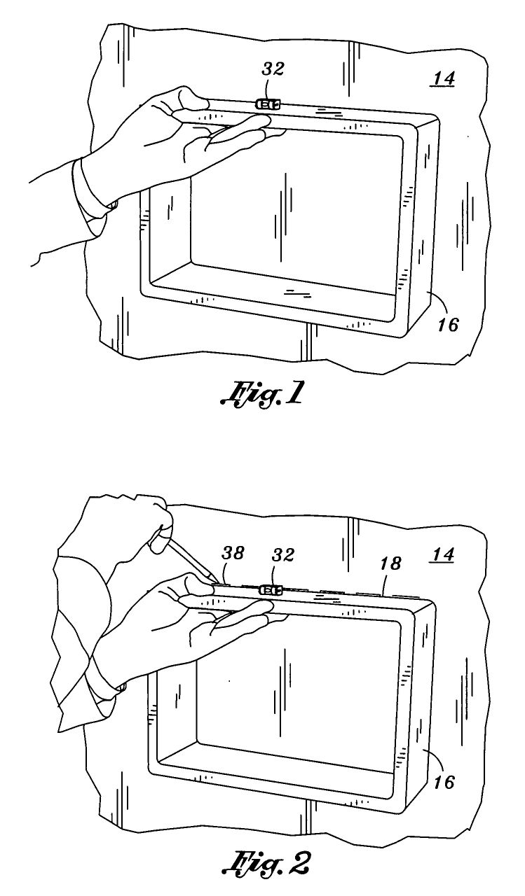

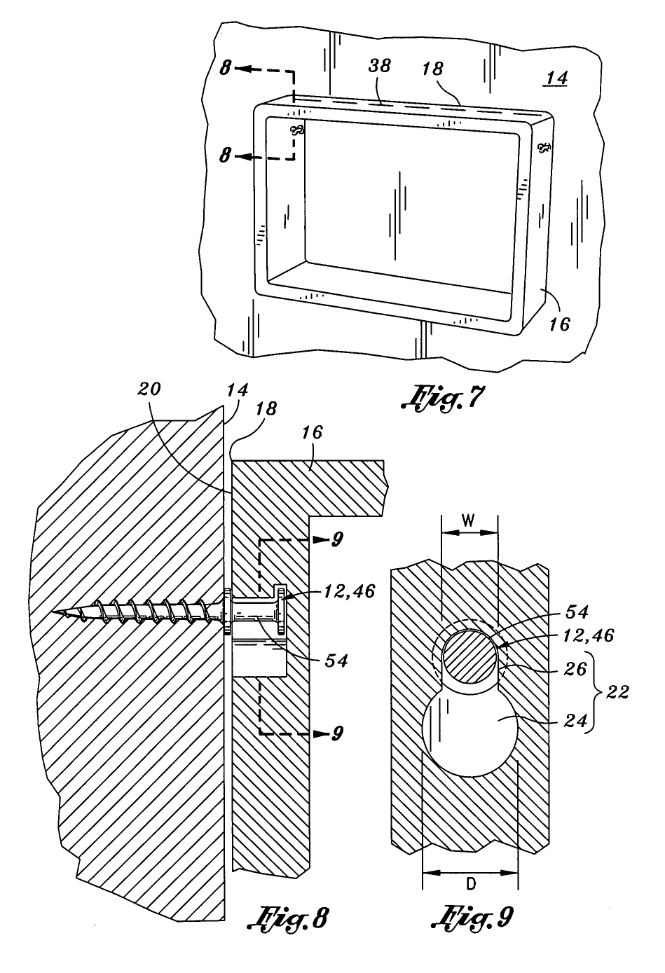

Referring now to FIGS. 1-13, there is provided a wall mounting kit. According to an aspect of the present invention, the wall mounting kit includes a pair of fasteners 12, a wall fixture 16 and a template 28. It is contemplated that a user will secure a wall fixture 16 to a wall 14 by inserting the fasteners 12 into the wall 14 and hanging the wall fixture 16 on the fasteners 12. A wall 14 may include any vertical support surface. Such a support surface may fully extend from the ground to the ceiling, or it may only partially extend therebetween.

It is understood that many different types of wall fixtures 16 are hung on a wall 14. A wall fixture 16 may include, but is not limited to, a frame, shelf, mirror, or other similar wall decoration or wall hanging member. The wall fixture 16 shown in FIGS. 1, 2, 6, and 7 is a rectangular frame. Wall fixtures 16 may be secured to a wall 14 for aesthetic appeal, or for functional reasons. For example, a frame containing a painting may be secured to the wall 14 for ornamental reasons, whereas a shelf may be secured to a wall 14 for functional reasons.

According to one embodiment, the wall fixture 16 is secured to the wall 14 via a pair of fasteners 12. The fasteners 12 may include nails, screws, tacks, hooks, or similar hardware known by those skilled in the art. Each fastener 12 is engageable with the wall 14. In this regard, the fastener 12 may be inserted or secured to the wall 14 and capable of supporting a load. In the preferred embodiment, the fastener 12 is a double headed screw 46 with high-helix angle threads, as is shown in FIGS. 10-12. The double headed screws 46 illustrated in FIGS. 10-12 each include a circular first head portion 52, a cylindrical shank portion 54, a circular second head portion 56 and a connector portion 58. The shank portion 54 extends axially between the first and second head portions 52, 56. The shank portion has a diameter “s” and the first head portion 52 has a diameter “d” which exceeds the diameter “s.” The connector portion 58 is externally threaded which enables the double headed screw 46 to cooperatively engage with the wall 14. The doubled headed screw 46 is inserted into the wall 14 until the second head portion 56 substantially abuts the wall 14, as is shown in FIG. 5. The high-helix angle threads shown in FIG. 10-12 enable the fastener 12 to support a larger load. Therefore, a screw 46 having high-helix angle threads may be used to support a heavy wall fixture 16 or a heavy load applied to a wall fixture 16.

The wall fixture 16 includes a reference edge 18 and a contact surface 20. The reference edge 18 is the edge along which the user traces a reference mark 38 on the wall 14, as is shown in FIG. 2. A discussion of the method of hanging the wall fixture 16, which includes drawing the reference mark 38, will be described in more detail below. The contact surface 20 is the surface that is adjacent to the wall 14 when the wall fixture 16 is secured to the wall 14. In this regard, the contact surface 20 typically abuts the wall 14 when the wall fixture 16 is secured thereto. However, it is understood that the contact surface 20 is not required to be completely flush with the wall 14.

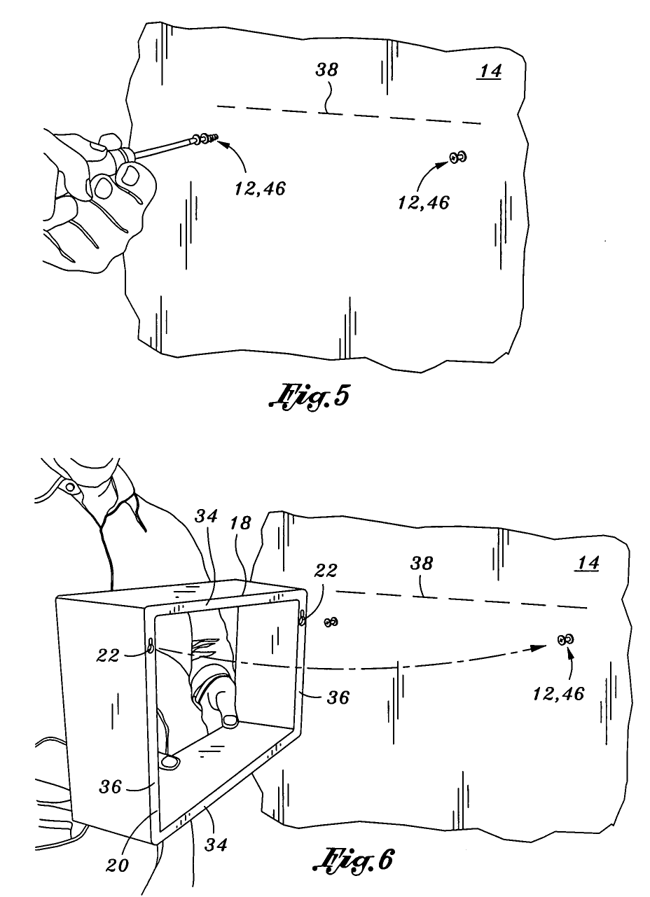

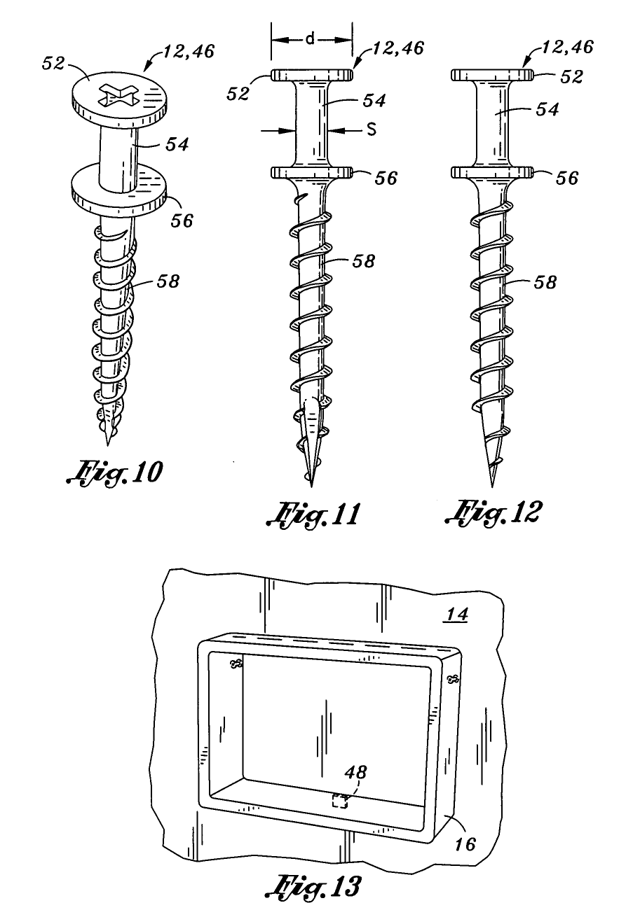

The wall fixture 16 further includes a pair of keyhole openings 22. The keyhole openings 22 are disposed within the contact surface 20, as is shown in FIG. 6. Each keyhole opening 22 is configured to receive a fastener 12. The keyhole openings 22 include as aperture portion 24 and a slot potion 26, which communicates with the aperture portion 24. As seen in FIG. 9, the slot portion 26 has a width “W,” with the aperture portion 24 having a diameter “D” which exceeds the width W of the slot portion 26. Each aperture portion 24 is capable of receiving the fastener 12. The aperture portion 24 diameter D exceeds the size of the fastener head. In the case of the doubled headed screw 46 illustrated in FIGS. 10-12, the first head portion 52 diameter “d” is smaller than the aperture portion 24 diameter D of the keyhole opening 22. In this regard, the first head portion 52 may be received into the keyhole opening 22 via the aperture portion 24. After the first head portion 52 is received into the aperture portion 24 of the keyhole opening 22, the fixture 16 is moved downwardly relative to the double headed screw 46. Consequently, the shank portion 54 of the double headed screw 46 moves within the slot portion 26 of the keyhole opening 22. In this regard, the slot portion 26 width W is greater than the shank 54 diameter “s” but less than the first head portion 52 diameter d. This prevents the fixture 16 from being pulled outwardly when it is engaged with the double headed screw 46. FIG. 11 and 12 further illustrate the connection between the double headed screw 46 and the keyhole opening 22.

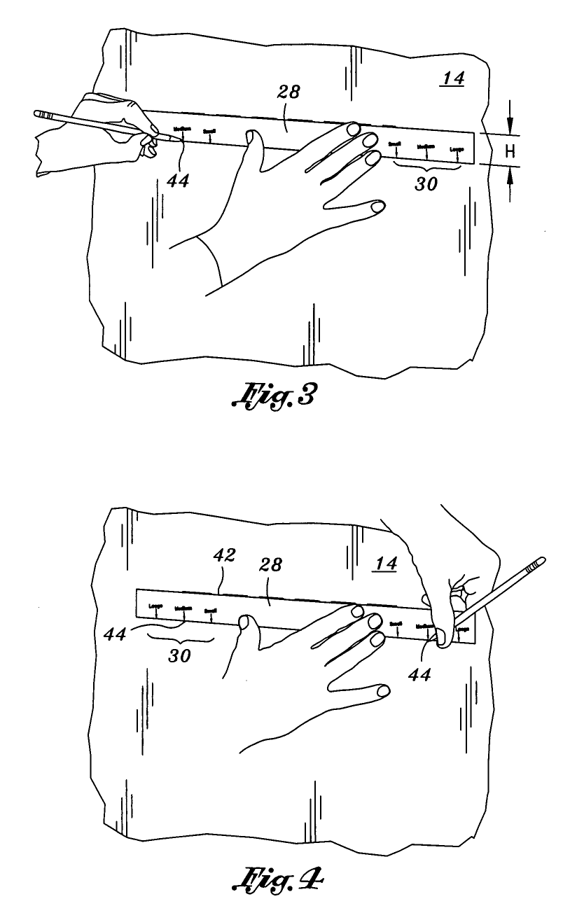

It is contemplated that the wall fixtures 16 will be available in different sizes. Consequently, the distance between the keyhole openings 22 will vary among wall fixtures 16. Therefore, the wall mounting kit also includes a template 28 which is used to ensure that the fasteners 12 are correctly spaced so they will be received within the keyhole openings aperture portions 24 on a specific wall fixture 16. Each keyhole opening aperture portion 24 defines a central axis. The spatial separation between the axes of the keyhole opening aperture portions 24 defines a second distance. The template 28 includes a marking guide 30 which illustrates the second distance. According to one particular implementation of the present invention, the marking guide 30 illustrates the second distance for wall fixtures 16 having different sizes. For example, the template 28 shown in FIGS. 3 and 4 includes a marking guide 30 illustrating the second distances for “small,” “medium,” and “large” wall fixtures 16.

Preferably, the template 28 is of a height “H” that is slightly less than a first distance, which is defined by the spatial separation between the distal end of slot portion 26 and the reference edge 18. The template height H is preferably slightly less than the first distance so the reference mark 38 is covered by the wall fixture 16 when the fixture 16 is hung on the fasteners 12, as can be seen in FIG. 7. The reference mark 38 is preferably covered by the fixture 16 because it is not aesthetically pleasing to have a marking on a wall 14. If the template height H is greater than the first distance, the reference mark 38 may be exposed. Although this may lead to an undesirable result, the template 28 may correctly illustrate the second distance. Therefore, there may be an embodiment where the template height is equal to or larger than the first distance.

According to another embodiment, the wall mounting kit may also include a leveling device 32, as is shown in FIGS. 1 and 2. The leveling device 32 is operative to ensure the wall fixture 16 is level with a horizontal plane. The leveling device 32 may be placed on a surface of the wall fixture 16 to ensure that it is level before drawing the reference mark 38. Furthermore, the leveling device 32 may be used to ensure that the reference mark 38 is level.

As was mentioned above, wall fixtures 16 may be available in a variety of different shapes and sizes. The wall fixture 16 shown in FIGS. 1, 2, 6, and 7 is rectangular. The contact surface 20 of a rectangular wall fixture 16 includes horizontal portions 34 and vertical portions 36. The keyhole openings 22 on the wall fixture 16 shown in FIG. 9 are located on the vertical portions 36.

In addition to the foregoing, it is expressly contemplated that the present invention also includes a methodology of securing a wall fixture 16 to a wall 14. The method includes drawing a reference mark 38 on the wall 14, as is shown in FIG. 2. After the reference mark 38 is drawn, the first edge 42 of the template 28 is placed adjacent to the reference mark 38. A pair of fastener marks 44 is then drawn on the wall 14 in accordance with the marking guide 30 on the template 28. As shown in FIGS. 3 and 4, the fastener marks 44 are drawn in accordance with the “medium” indicators on the template marking guide 30. The fastener marks 44 represent the location on the wall 14 where the fasteners 12 should be inserted. The spatial separation between the pair of fastener marks 44 is equal to the second distance. The user then inserts the fasteners 12 into the wall 14 at the fastener marks 44. Once the fasteners 12 are placed in the wall 14, the wall fixture 16 is hung on the fasteners 12, as depicted in FIGS. 6 and 7, and as described above. When the wall fixture 16 is connected to the fasteners 12, the reference mark 38 is preferably covered by the wall fixture 16. FIG. 7 shows the reference mark 38 covered by the wall fixture 16.

When the wall fixture 16 is connected to the fasteners 12, the fixture 16 may become disconnected from the fasteners 12 if the fixture 16 is inadvertently bumped. Therefore, the wall mounting kit may include an attachment device 48 that is capable of preventing the fixture 16 from inadvertently disconnecting from the fasteners 12. FIG. 13 shows a wall fixture 16 secured to a wall 14 with an attachment device 48 connected to the wall 14 and the wall fixture 16. Preferably, the attachment device 48 includes double sided tape, however other similar attaching devices known by those skilled in the art may also be used.

The method may also include the step of affixing an attachment device 48 to the contact surface 20. The attachment device 48 may be placed near the bottom corners of the contact surface 20. The attachment device 48 may also be placed anywhere along the contact surface 20 of the wall fixture 14. As shown in FIG. 13, the attachment device 48 is placed along a bottom portion of the contact surface 20. After the attachment device 48 is placed on the contact surface 20, the wall fixture 16 is hung on the fasteners 12 and adjusted into a desired position on the wall 14. The user then applies pressure to the wall fixture 16 to ensure that the attachment device 48 bonds to the wall 14.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A wall mounting kit comprising:
a pair of fasteners, each fastener being cooperatively engageable with a wall;
a wall fixture including:
a reference edge;
a contact surface that is adjacent to the wall when the wall fixture is secured thereto; and
a pair of keyhole openings disposed within the contact surface, each keyhole opening having an aperture portion, each keyhole opening being operative to receive a respective one of the pair of fasteners such that the wall fixture is secured to the wall, wherein a first distance is defined by the spatial separation between the keyhole opening and the reference edge, and a second distance is defined by the spatial separation between the centers of the keyhole aperture portions; and
a template having a marking guide operative to illustrate the second distance.

2. The wall mounting kit of claim 1, wherein the pair of fasteners are double headed screws.

3. The wall mounting kit of claim 2, wherein the double headed screws include a first head portion, a second head portion, a shank portion extending between the first and second head portions, and a connector portion protruding from the second head portion.

4. The wall mounting kit of claim 3, wherein the connector portion includes high-helix angle threads.

5. The wall mounting kit of claim 1, further comprising a leveling device operative to ensure the wall fixture is level with a horizontal plane.

6. The wall mounting kit of claim 1, wherein the wall fixture is a frame having a quadrangular contact surface, including horizontal portions and vertical portions.

7. The wall mounting kit of claim 6, wherein the keyhole openings are located on the vertical portions of the contact surface.

8. The wall mounting kit of claim 1, wherein the template is of a height which is slightly less than the first distance.

9. A wall mounting kit comprising:
a pair of fasteners, each fastener being cooperatively engageable with a wall;
a wall fixture including:
a reference edge;
a contact surface that is adjacent to the wall when the wall fixture is secured thereto; and
a pair of keyhole openings disposed within the contact surface, each keyhole opening having an aperture portion, each keyhole opening being operative to receive a respective one of the pair of fasteners such that the wall fixture is secured to the wall, wherein a first distance is defined by the spatial separation between the keyhole opening and the reference edge, and a second distance is defined by the spatial separation between the centers of the keyhole aperture portions; and
a template having a marking guide operative to illustrate the second distance, wherein the template is of a height which is slightly less than the first distance.

10. The wall mounting kit of claim 9, further comprising a leveling device operative to ensure the wall fixture is level with a horizontal plane.

11. The wall mounting kit of claim 9, wherein the wall fixture is a frame having a quadrangular contact surface, including horizontal portions and vertical portions.

12. The wall mounting kit of claim 11, wherein the keyhole openings are located on the vertical portions of the contact surface.

13. The wall mounting kit of claim 9, wherein the pair of fasteners are double headed screws.

14. The wall mounting kit of claim 13, wherein the doubled headed screws include a first head portion, second head portion, a shank portion extending between the first and second head portions and a connector portion protruding from the second head portion.

15. The wall mounting kit of claim 14, wherein the connector portion includes high-helix angle threads.

16. A method of securing a wall fixture to a wall, the wall fixture having a reference edge, a contact surface and a pair of keyhole openings disposed within the contact surface, each keyhole opening having an aperture portion, wherein a first distance is defined as the spatial separation between the keyhole opening and the reference edge, and a second distance is defined by the spatial separation between the centers of the keyhole aperture portions, the method comprising the steps of:
(a) drawing a reference mark on the wall;
(b) placing a template adjacent to the reference mark, the template having a first edge and a marking guide, the marking guide being operative to illustrate the second distance, the template being placed such that the first edge is adjacent to the reference mark;
(c) drawing a pair of fastener marks on the wall, wherein the spatial separation between the fastener marks is substantially equal to the second distance;
(d) inserting a pair of fasteners into the wall, each fastener being inserted at a respective one of the pair fastener marks; and
(e) connecting the wall fixture and the pair of fasteners such that a respective one of the pair of fasteners is inserted into a respective one of the keyhole openings.

17. The method of claim 16, wherein step (d) comprises inserting a pair of doubled headed screws into the wall.

18. The method of claim 16, wherein the template is of a height that is slightly less than the first distance.

19. The method of claim 16, further comprising the steps of:
(f) affixing an attachment device to the contact surface of the wall fixture;
(g) adjusting the wall fixture into a desired position on the wall; and
(h) applying pressure to the wall fixture to ensure that the attachment device bonds to the wall.

20. The method of claim 19, wherein step (f) comprises affixing double-sided tape to the contact surface.
